(19) United States
(12) Patent Application Publication
(10) Pub. No.: US 2014/0002755 A1
(43) Pub. Date: Jan. 2, 2014

(54) VIDEO DISPLAY DEVICE

(71) Applicant: Kabushiki Kaisha Toshiba, Tokyo (JP)

(72) Inventors: Takao MITSUYOSHI, Hidaka-shi (JP); Takayoshi TOMIOKA, Fukaya-shi (JP)

(73) Assignee: Kabushiki Kaisha Toshiba, Tokyo (JP)

(21) Appl. No.: 14/012,549

(22) Filed: Aug. 28, 2013

Related U.S. Application Data
(63) Continuation of application No. PCT/JP2013/058186, filed on Mar. 14, 2013.

(30) Foreign Application Priority Data
Jun. 27, 2012 (JP) 2012-144364

(51) Int. Cl. H04N 5/64

(52) U.S. Cl. CPC H04N 5/64
USPC 348/836

(57) ABSTRACT

According to one embodiment, a video display device includes: a housing provided with a display device; a supporting structure configured to support the housing; and a member connecting to the supporting structure, the member expanding, when the supporting structure is placed on a plane, along a direction intersecting a direction orthogonal to the plane, wherein the member is configured to comprise a transparent area not overlapping with the supporting structure on a side of the plane of the housing viewed from a direction orthogonal to the plane when the supporting structure is placed on the plane, and is connected to the supporting structure on a circumferential edge side of the member.

### CROSS-REFERENCE TO RELATED APPLICATIONS

This application is a continuation of PCT international application Ser. No. PCT/JP2013/058186, filed Mar. 14, 2013, which designates the United States, incorporated herein by reference, and which is based upon and claims the benefit of priority from Japanese Patent Application No. 2012-144364, filed Jun. 27, 2012, the entire contents of which are incorporated herein by reference.

### FIELD

Embodiments described herein relate generally to a video display device.

### BACKGROUND

Conventionally, some video display devices are known in which a housing thereof provided with a display device is supported by a stand including a flat portion.

When a supporting structure of a housing with a display device is accommodated in a flat portion of a stand, desirable video display devices have fewer inconveniences of, for example, an increase in the size of the supporting structure and a more complicated construction of the supporting structure.

Embodiments of the present invention aim to obtain, as one example, a video display device comprising a novel structure with fewer inconveniences concerning a supporting portion having a flat portion.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an example of a video display device according to a first embodiment, viewed from the front side;

FIG. 2 is an exemplary perspective view of the example of the video display device in the first embodiment, viewed from the rear side;

FIG. 3 is an exemplary plan view (top view) of an example of a supporting portion of the video display device in the first embodiment;

FIG. 4 is an exemplary side view of the example of the supporting portion of the video display device in the first embodiment;

FIG. 5 is an exemplary cross-sectional view taken along the line V-V in FIG. 3 in the first embodiment;

FIG. 6 is an exemplary perspective view of an example of a fourth supporting portion of the supporting portion of the video display device in the first embodiment;

FIG. 7 is an exemplary perspective view illustrating an example of the supporting portion of the video display device in the first embodiment, in a condition in which the fourth supporting portion is combined with a second supporting portion;

FIG. 8 is an exemplary perspective view illustrating an example of a condition in which the structure depicted in FIG. 7 is combined with a fifth supporting portion in the first embodiment;

FIG. 9 is an exemplary perspective view illustrating an example of a condition in which the structure depicted in FIG. 8 is combined with a first supporting portion in the first embodiment;

FIG. 10 is an exemplary perspective view illustrating an example of a condition in which the structure depicted in FIG. 9 is combined with a third supporting portion in the first embodiment;

FIG. 11 is an exemplary perspective view of an example of a part of the supporting portion of the video display device in the first embodiment, viewed from the bottom side;

FIG. 12 is an exemplary exploded cross-sectional view taken along the line XII-XII in FIG. 11 in the first embodiment;

FIG. 13 is an exemplary cross-sectional view taken along the line XII-XII in FIG. 11 in the first embodiment;

FIG. 14 is an exemplary cross-sectional view of a part of a supporting portion according to a modification of the first embodiment, viewed at the position equivalent to FIG. 13;

FIG. 15 is an exemplary perspective view of an example of a supporting portion comprised in a video display device according to a second embodiment; and

FIG. 16 is an exemplary perspective view of an example of a supporting portion comprised in a video display device according to a third embodiment.

### DETAILED DESCRIPTION

In general, according to one embodiment, a video display device comprises: a housing provided with a display device comprising a screen; a first supporting portion in a plate-like shape comprising a transparent area, the transparent area being, when the first supporting portion is placed on a plane, on a side of the plane of the housing in a direction orthogonal to the plane; a second supporting portion positioned at a circumferential edge portion of the first supporting portion; a third supporting portion supported by the first supporting portion and the second supporting portion and configured to support the housing to be rotatable about an axis along a direction intersecting the plane when the first supporting portion is placed on the plane; and a fourth supporting portion configured to support the first supporting portion to be in a position in which a first end portion of the first supporting portion positioned on a front side of the screen is closer to the plane than a second end portion on a side opposite to the first end portion of the first supporting portion when the first supporting portion is placed on the plane.

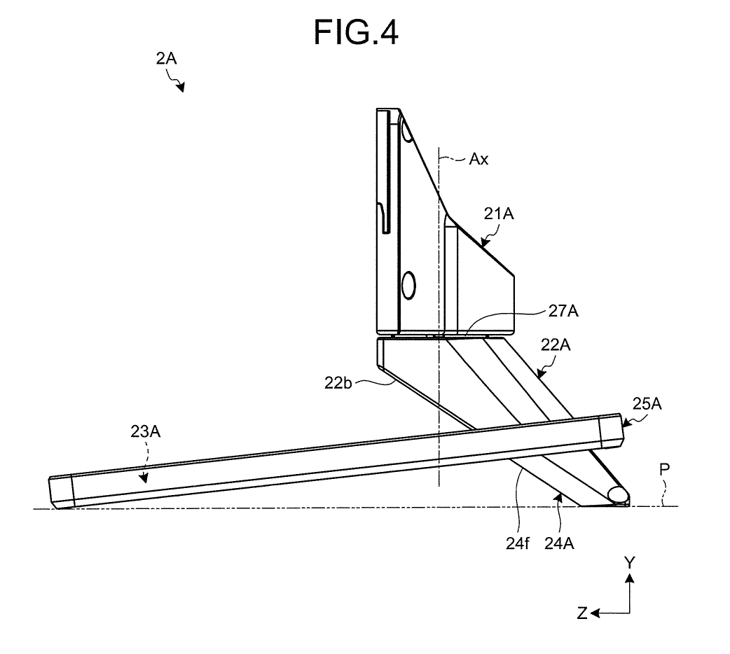

A plurality of exemplary embodiments and a modification in the following comprise the same or similar constituent elements. In the following description, the same or similar constituent elements are given with common reference numerals or signs, and redundant explanations are omitted. Furthermore, appropriate drawings are recited in the following description with some directions defined for the sake of convenience. At a central position (a neutral position) in a movable range of a housing 3A, an X direction is a right-hand direction in the frontal view (an anterior view, i.e., a left-hand direction in the back view (rear view)) of a screen 4a, a Y direction is an upward direction and a Z direction is the normal direction (front direction) of the screen 4a. In the following embodiments, as one example, when a supporting portion 2A of a television receiver 1A is placed on a plane P (a placement surface or a placement plane, see FIG. 4), the Y direction lies along the normal direction of the plane P, and the X direction and the Z direction are in parallel with the plane P.

While the following embodiments and modification describe examples in which a video display device is configured as a television receiver, the video display devices according to the embodiments are not restricted to this. The video display devices in the embodiments can be each configured as an electronic device comprising a stand having a flat supporting portion, specifically, for example, an all-in-one (AIO) personal computer, a smart television, a display device, and a monitor device.

### First Embodiment

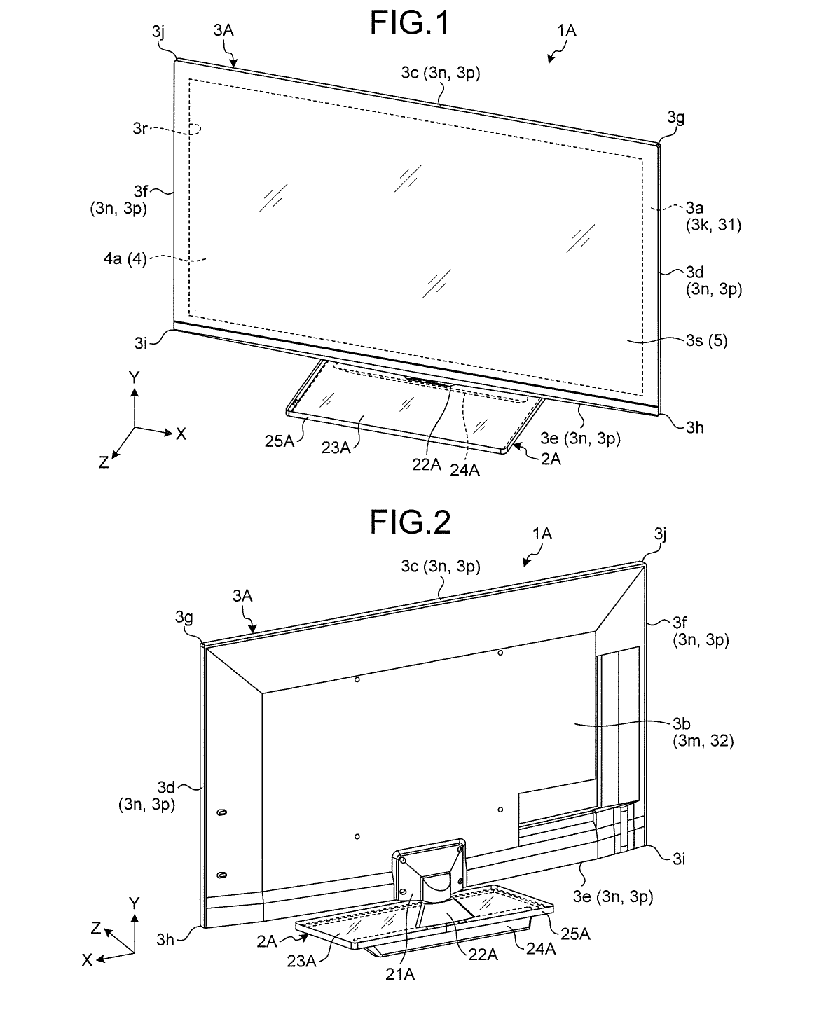

In a first embodiment, as illustrated in FIGS. 1 and 2 as one example, the television receiver 1A (a video display device or an electronic device) comprises the supporting portion 2A and the housing 3A. Specifically, on the housing 3A, a display device 4 is provided. The housing 3A houses therein at least a part of the display device 4. The supporting portion 2A (a stand, a pedestal portion, or a leg portion) supports the housing 3A. The supporting portion 2A can support the housing 3A to be movable (rotatable). In the first embodiment, as one example, the supporting portion 2A supports the housing 3A to be rotatable about an axis Ax that lies along a direction orthogonal to a plane P (see FIG. 4) when the supporting portion 2A is placed on the plane P. In other words, the housing 3A is supported by the supporting portion 2A to swivel. The supporting portion 2A can support the housing 3A, for example, to tilt or to pivot.

The housing 3A, in the first embodiment, as illustrated in FIGS. 1 and 2 as one example, is constructed in a quadrangular shape (in the first embodiment, a rectangular shape as one example) in the frontal view and in the back view. Furthermore, the housing 3A, in the first embodiment, as one example, is constructed in a rectangular parallelepiped shape to be thin and flat in a front-back direction. The housing 3A comprises a surface 3a (an anterior surface, a front face, or a surface portion) and a surface 3b (a rear surface, a back surface, or a surface portion) on the side opposite to the surface 3a. Both the surface 3a and the surface 3b extend (expand) along a direction intersecting the thickness direction of the housing 3A (in the first embodiment, as one example, in an orthogonal direction, i.e., along the XY plane). The surface 3a and the surface 3b are roughly in parallel with each other. The housing 3A further comprises, as illustrated in FIGS. 1 and 2, four end portions 3c to 3f (sides or edge portions) and four corners 3g to 3j (protruding portions, rounded portions, or end portions) in the frontal view. The end portions 3c and 3e are examples of longer sides. The end portions 3d and 3f are examples of shorter sides.

The housing 3A further comprises, as one example, a wall portion 3k (a portion, a plate, a frame, a front wall portion, a surface wall portion, or a top wall portion) having the surface 3a, and a wall portion 3m (a portion, a plate, a rear wall portion, a back wall portion, or a bottom wall portion) having the surface 3b. The wall portions 3k and 3m are in a quadrangular shape (in the first embodiment, a rectangular shape as one example). The housing 3A further comprises four wall portions 3n (portions, plates, side wall portions, end wall portions, standing wall portions, or extending portions) having surfaces 3p (side surfaces or circumferential surfaces) extending between the wall portion 3k and the wall portion 3m. The wall portion 3k has an opening 3r in a quadrangular shape as one example. Therefore, the wall portion 3k is in a quadrangular and frame-like shape. In the first embodiment, as one example, the opening 3r is covered with a transparent plate-like member 3s (a portion, a plate, a mask, a cover, or glass).

Furthermore, the housing 3A can be constructed with a plurality of components (segmented bodies) combined. The housing 3A, in the first embodiment, as one example, comprises a housing member 31 (a front side member, a mask, a mask portion, a cover, a front cover, a cover portion, a portion, or an area) having at least the wall portion 3k, and a housing member 32 (a back side member, a base, a base portion, a bottom, a bottom portion, a cover, a rear cover, a cover portion, a portion, or an area) having at least the wall portion 3m. The wall portions 3n are comprised in at least one of the housing member 31 and the housing member 32 (for example, the housing member 32). Moreover, the housing 3A can comprise another housing member (an intermediate member, an isolating member, a barrier wall member, a wall member, an intervening member, a covering member, an inner plate, a middle plate, a middle frame, a shield, a portion, or an area, not depicted) positioned between the housing member 31 and the housing member 32. The housing 3A can be composed of metallic or synthetic resin material, for example. The inner sides of the housing member 31 and the housing member 32 of the housing 3A can be provided with wall portions such as ribs (projecting portions or projecting wall portions, not depicted). These wall portions facilitate an increase in rigidity of the housing 3A.

In the first embodiment, on the surfaces 3a, 3b, and 3p of the housing 3A, as one example, connectors, operation modules, a camera module (a camera or an imaging device), and others (not depicted) can be provided. The connectors can be, for example, a connector for a power supply cable, a universal serial bus (USB) connector, a card connector, and connectors for earphones and a microphone. The operation modules can be, for example, a push button, a push switch, a slide switch, a pointing device, and a dial.

In the first embodiment, as illustrated in FIG. 1 as one example, the screen 4a of the display device 4 (a display module, a display, or a panel) positioned on the surface 3a side is visible from the front (outside) of the housing 3A through the opening 3r and the member 3s. The display device 4 is constructed in a quadrangular shape (in the first embodiment, a rectangular shape as one example) in the frontal view. The display device 4 is further constructed in a rectangular parallelepiped shape to be thin and flat in the front-back direction. The display device 4, for example, is a liquid crystal display (LCD) or an organic electro-luminescent display (GELD).

In the first embodiment, on the front side (the face side or the wall portion 3k side) of the display device 4, as one example, a touch panel 5 (as one example, an input operation panel, a touch sensor, or an operation module) can be provided. The touch panel 5 can be provided, as one example, on the reverse side (the display device 4 side, the back side, or the rear side) of the member 3s. In this case, the touch panel 5 is constructed in a transparent and relatively thin quadrangular shape, covering the screen 4a. A user, for example, can execute input process by performing an operation of touching, pressing, or rubbing the touch panel 5 with a finger or a component (for example, a stylus, not depicted), or moving the finger or the stylus near the touch panel 5. The light emitted from the screen 4a of the display device 4 goes out ahead (outside) of the housing 3A from the opening 3r of the wall portion 3k, passing (transmitting) through the touch panel 5 and the member 3s.

In the first embodiment, as one example, the housing 3A houses therein one or more substrates (a circuit board, a control board, a main board, electrical components, or components, not depicted) on the rear side (the reverse side, the back side, the wall portion 3m side, or the side opposite to the screen 4a) of the display device 4. These substrates are provided roughly in parallel with the display device 4. The substrates can be fixed on the rear surface (not depicted) of the display device 4, being spaced from the rear surface. The substrates are provided in a condition away from the wall portions 3k, 3m, 3n, and others, in other words, in a condition with a space (gap) formed between themselves and the wall portions 3k, 3m, 3n, and others.

In the first embodiment, on the substrates, as one example, a plurality of components (not depicted) can be mounted, for example, a central processing unit (CPU), a graphics controller, power supply circuit components, a platform controller hub (PCH), a memory slot connector, an LCD connector, an input/output (I/O) connector, a power coil, elements, and connectors. Furthermore, the control circuit can comprise, for example, a video signal processing circuit, a tuner, a High-Definition Multimedia Interface (HDMI) signal processor, an audio video (A/V) input terminal, a remote control signal receiver, a controller, a selector, an on-screen display interface, a storage module (for example, a read only memory (ROM), a random access memory (RAM), a hard disk drive (HDD), and a solid state drive (SSD)), and an audio signal processing circuit. The control circuit controls such operations as the output of videos (such as movies and still pictures) on the screen 4a of the display device 4, the output of audio from a speaker (not depicted), and light emission of a light emitting diode (LED, not depicted). The display device 4, the speaker, and the LED are examples of output modules. The housing 3A can house therein a plurality of substrates. The housing 3A can also house therein electrical components and electronic components not provided on the substrates.

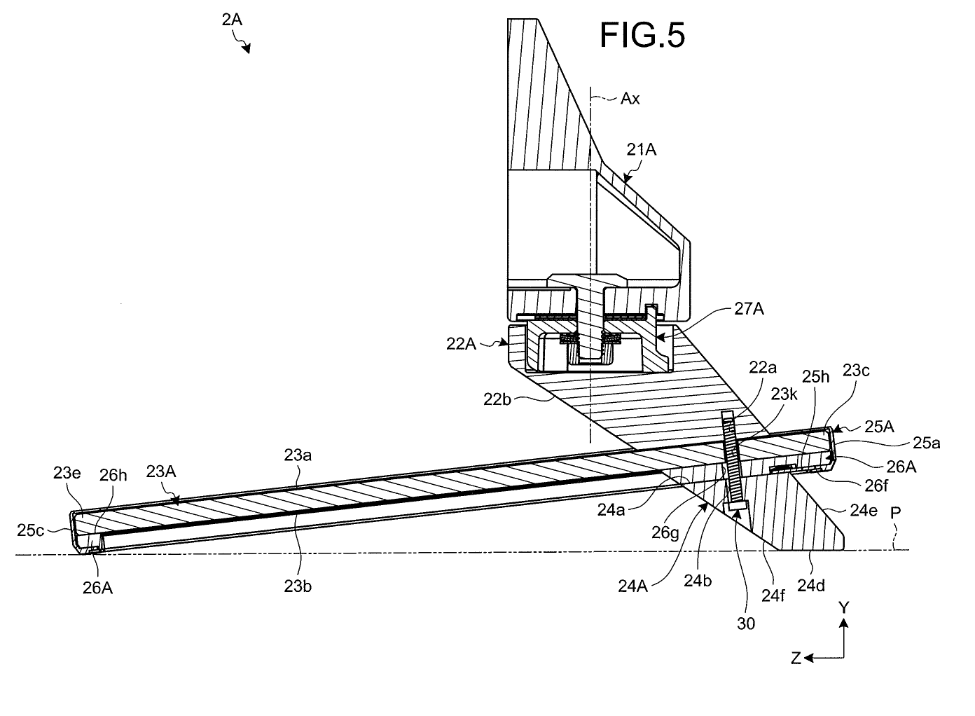

In the first embodiment, as illustrated in FIGS. 2 to 5 as one example, the supporting portion 2A (a supporting structure or a stand) comprises a plurality of components 21A to 26A. The component 21A, as illustrated in FIG. 2, is attached to a central portion of the end portion 3e of the wall portion 3m (the surface 3b) of the housing 3A. The component 21A is an example of a connecting portion between the supporting portion 2A and the housing 3A. The component 21A, as illustrated in FIG. 5, is supported by the component 22A (a third supporting portion, a supporting portion, a member, a portion, or a rotary supporting portion) to be rotatable about the axis Ax via a swivel structure 27A. The axis Ax lies along a direction orthogonal to a plane P when the supporting portion 2A is placed on the plane P. The component 22A comprises an inclined portion 22b on the front side (the left-hand side in FIGS. 4 and 5) of the screen 4a. The inclined portion 22b is inclined, as it extends towards the back side of the screen 4a, from the side away from the plane P to the side closer to the plane P (downwards to the right in FIGS. 4 and 5) when placed on the plane P. The components 21A and 22A can be composed of, as one example, metallic or synthetic resin material.

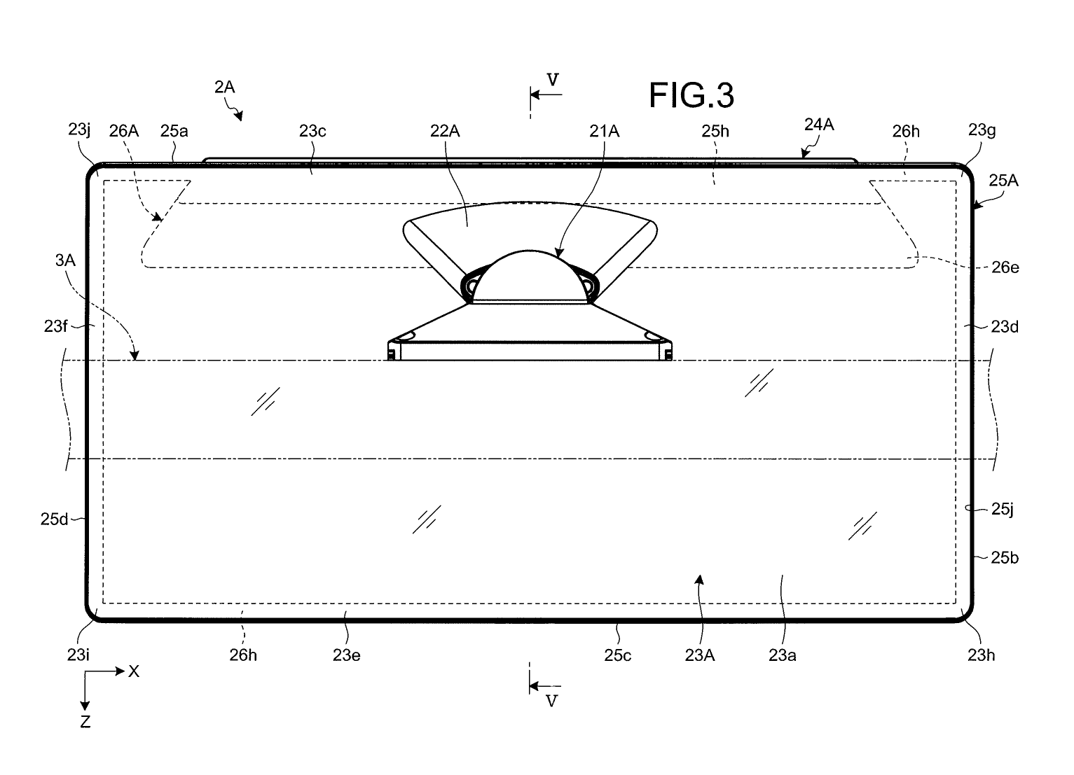

In the first embodiment, as illustrated in FIGS. 3 and 5 as one example, the component 23A (a first supporting portion, a supporting portion, a member, or a portion) is flat and is constructed in a quadrangular (in the first embodiment, a rectangular shape as one example) and plate-like shape. The component 23A comprises a surface 23a (an upper surface, a top surface, or an obverse surface) and a surface 23b (a lower surface, a bottom surface, or a reverse surface) on the side opposite to the surface 23a. The component 23A further comprises four end portions 23c to 23f (sides or edge portions) and four corners 23g to 23j (protruding portions, rounded portions, or end portions). The end portions 23c and 23e are examples of longer sides. The end portions 23d and 23f are examples of shorter sides. The corners 23g to 23j are constructed in a rounded shape.

In the first embodiment, as one example, the component 23A has a transparent (clear and colorless, or clear and colored; in the first embodiment, clear and colorless as one example) area, and is composed of glass, tempered glass, special glass, laminated glass, or clear synthetic resin material. The transparent area of the component 23A lies at a central portion of the component 23A (a portion on the inner side than circumferential edge portions (the end portions 23c to 23f)) and on the plane P side of the housing 3A in the frontal view (a line of sight in a direction orthogonal to the plane P, i.e., as viewed in FIG. 3). In the first embodiment, as one example, the whole component 23A is clear and colorless. The component 23A can be partially coated, masked, or printed. In other words, the component 23A can have portions not transparent. The non-transparent portions can be provided at the circumferential edge portions of the component 23A or the portions at which the other components 21A, 22A, and 24A to 26A make contacts or visually overlap. In the first embodiment, as one example, because the component 23A is transparent, some visual effects can be achieved, for example, the back side of the supporting portion 2A is visible from the frontal side of the display device 4, and the surroundings of the supporting portion 2A look more spacious and appear brighter. The component 23A is further provided with openings 23k (in the first embodiment, through holes as one example) through which binding tools 30 (see FIG. 5) pass.

In the first embodiment, as illustrated in FIGS. 3 to 6 as one example, the component 24A (a fourth supporting portion, a supporting portion, a member, a portion, or a second supporting portion) is constructed in a long bar shape extending along the plane P. The component 24A extends along the end portion 23c of the component 23A. The component 24A comprises a planar surface 24a (an upper surface, a top surface, a contacting surface, or a supporting surface). On the surface 24a, other components (in the first embodiment, the components 25A and 26A as one example) make contacts. In this manner, making the surface 24a planar facilitates lowering of contact pressure with the other components. The component 24A further has forms and structures to bind with the other components (for example, openings 24b (through holes) and binding portions 24c (female threaded holes)). On the inside of the component 24A, a void (a space or a chamber, not depicted) can be provided. In this case, an opening of the void can be bored, as one example, in a surface 24d (a lower surface, a bottom surface, a contacting surface, or a supporting surface) or a surface 24e (a back surface, a rear surface, or a reverse surface). The component 24A further comprises an inclined portion 24f. The inclined portion 24f is inclined, as it extends from the component 22A towards the rear side (back side) of the screen 4a, from the side away from the plane P to the side closer to the plane P (downwards to the right in FIGS. 4 and 5) when placed on the plane P. In the first embodiment, as one example, the component 24A is inclined as a whole. The component 24A can be structured to comprise a case and wall portions (ribs). The component 24A can be composed of, as one example, metallic or synthetic resin material. The component 24A can be provided being divided into a plurality of pieces.

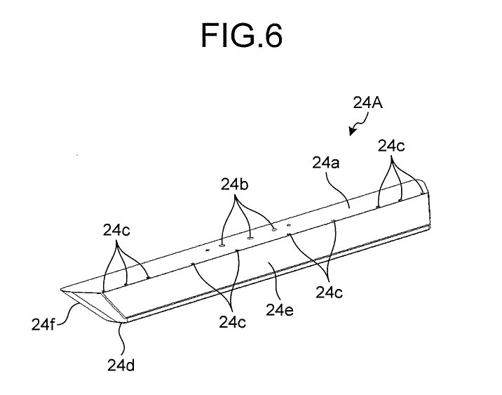

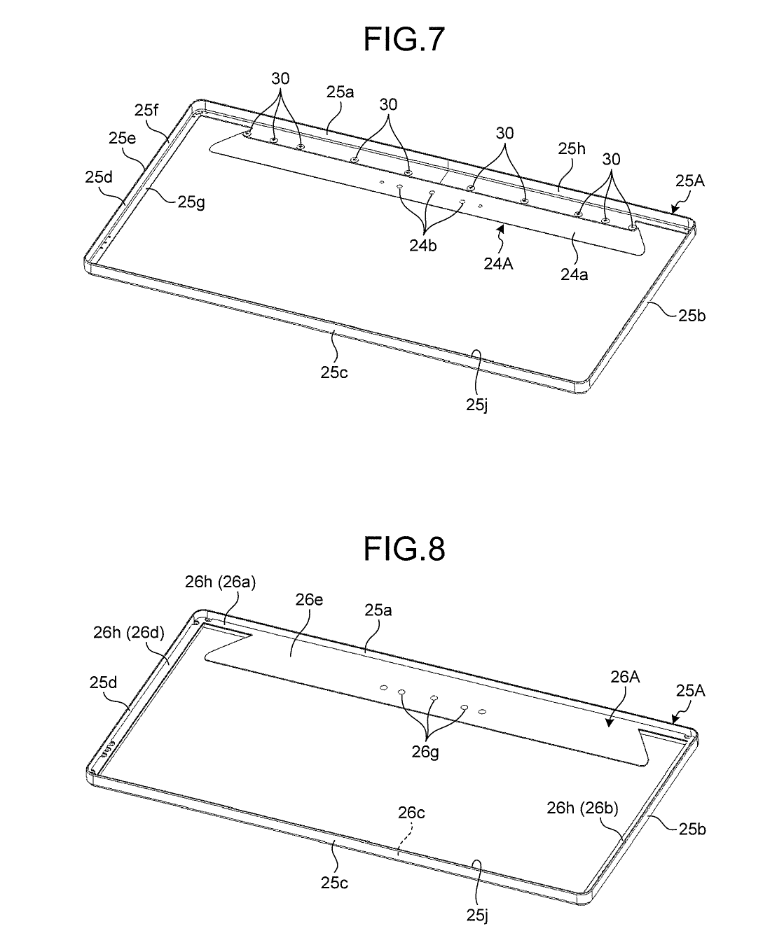

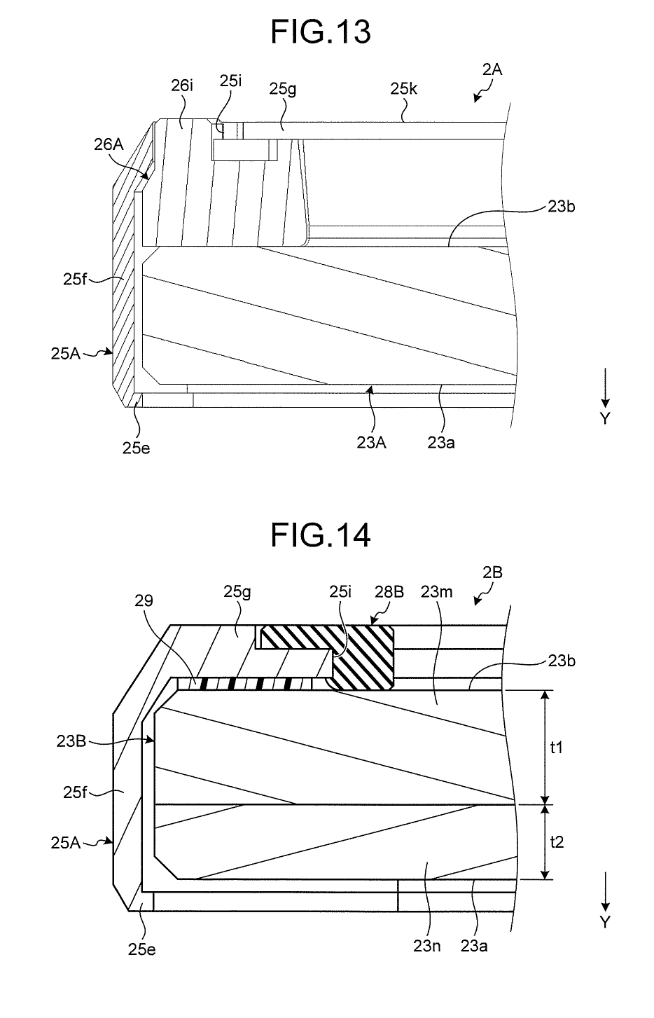

In the first embodiment, as illustrated in FIGS. 3 and 7 as one example, the component 25A (a second supporting portion, a supporting portion, a member, or a portion) is constructed in a quadrangular (rectangular) and frame-like shape to surround the surroundings of the component 23A. The component 25A comprises, as illustrated in FIG. 7, end portions 25a to 25d lying along the end portions 23c to 23f of the component 23A. Furthermore, as illustrated in FIGS. 12 and 13, for example, each of the end portions 25a to 25d has wall portions 25e to 25g covering three sides. More specifically, each of the end portions 25a to 25d has a C-shaped cross-section. The component 25A further comprises a wall portion 25h (a flange portion or a connecting portion) projecting (jutting) towards the inside of the frame from the wall portion 25g of the end portion 25a that lies along the end portion 23c. The wall portion 25h has openings (through holes, cutouts, or the like; in the first embodiment, through holes as one example, not depicted). As illustrated in FIG. 7, the wall portion 25h is placed on the surface 24a of the component 24A. The binding tools 30 through the openings provided on the wall portion 25h are then bound to the binding portions 24c of the component 24A (see FIG. 6), whereby the component 25A and the component 24A are bound (integrated). The component 25A can be composed of, as one example, metallic or synthetic resin material. Furthermore, the component 25A can be constructed, as one example, by extrusion. The component 25A has an opening 25j. The opening 25j accommodates the component 23A.

In the first embodiment, as one example, the component 25A has necessary rigidity and strength, and has a function to support the housing 3A in parallel with the component 23A. In other words, even when the supporting function of the component 23A is involuntarily impaired for some reason, the necessary supporting function is likely to be ensured by the component 25A. In contrast, even when the supporting function of the component 25A is involuntarily impaired for some reason, the necessary supporting function is likely to be ensured by the component 23A. This means that, in the first embodiment, as one example, for the function to support the housing 3A, a dual system is constructed by the component 23A and the component 25A.

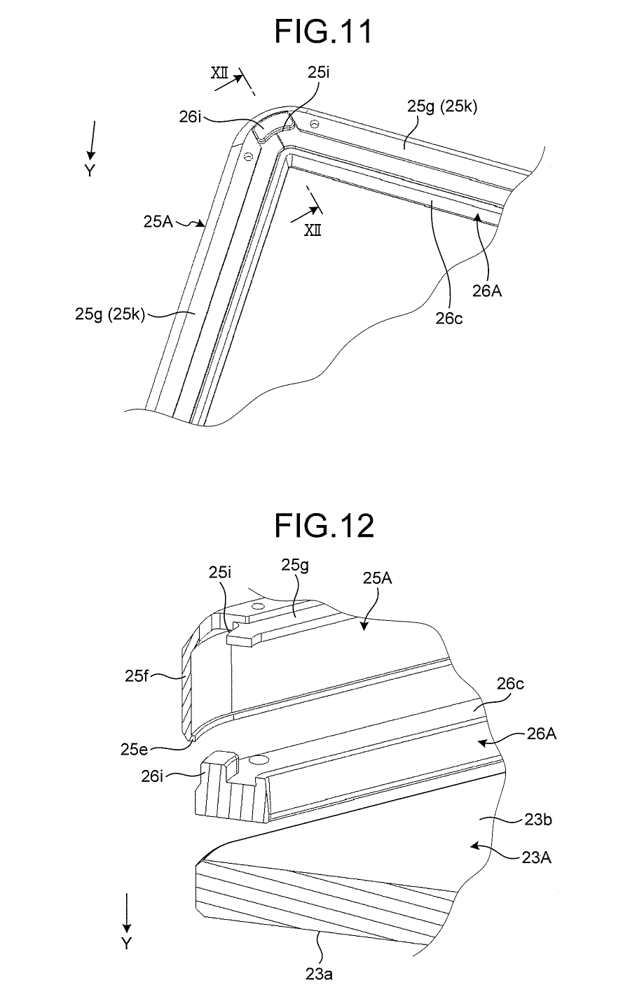

In the first embodiment, as one example, the component 25A further has a function to protect the end portions 23c to 23f (end faces) of the component 23A. More specifically, as compared with when the end portions 23c to 23f of the component 23A are being exposed, the component 23A is harder to be damaged. Furthermore, the component 25A comprises the wall portion 25g (the end portion 25c covering the end portion 23e, see FIGS. 11 to 13) that covers the end portion 23e on the side of the plane P (the lower side). This prevents an external force (a reaction force) from the placement surface side (the plane P side, for example) from directly acting on the end portion 23e, and thus the end portion 23e is harder to be damaged.

In the first embodiment, as one example, the component 26A (a fifth supporting portion, a supporting portion, a member, or a portion), as illustrated in FIG. 5, is wedged (lies) between the component 25A (the wall portion 25h thereof) and the component 23A (the surface 23b thereof) and between the component 24A (the surface 24a thereof) and the component 23A (the surface 23b thereof). The component 26A, as illustrated in FIG. 8, is constructed in a plate-like and frame-like shape, and comprises end portions 26a to 26d lying along the respective end portions 23c to 23f of the component 23A. The component 26A further comprises a wall portion 26e (a connecting portion or a flange portion) projecting (jutting) towards the inside of the frame from the end portion 26a that lies along the end portion 23c. The wall portion 26e has openings 26g (through holes, cutouts, or the like; in the first embodiment, through holes as one example). On the reverse side of the wall portion 26e in FIG. 8, a recessed portion 26f (see FIG. 5) accommodating the wall portion 25h is provided. The component 26A can be composed of, as one example, synthetic resin or metallic material. When the component 26A is constructed with a material that is softer, more deformable, or lower in strength than those of the component 23A, the component 25A, and others, the component 26A has a function as a buffering member (an impact absorbing member) that softens a load acting on the component 23A, or a function as a protecting member that protects the component 23A. When the component 26A is constructed with a relatively hard material such as metallic material, a buffering member (for example, a sheet-like buffering member or protecting member) lies between the component 26A and at least the component 23A. Furthermore, on a surface 26h (an upper surface, a top surface, or an obverse surface) of the component 26A, patterns, designs, characters, forms, and others can be applied. In other words, the component 26A can be used as a decorative member or a design member.

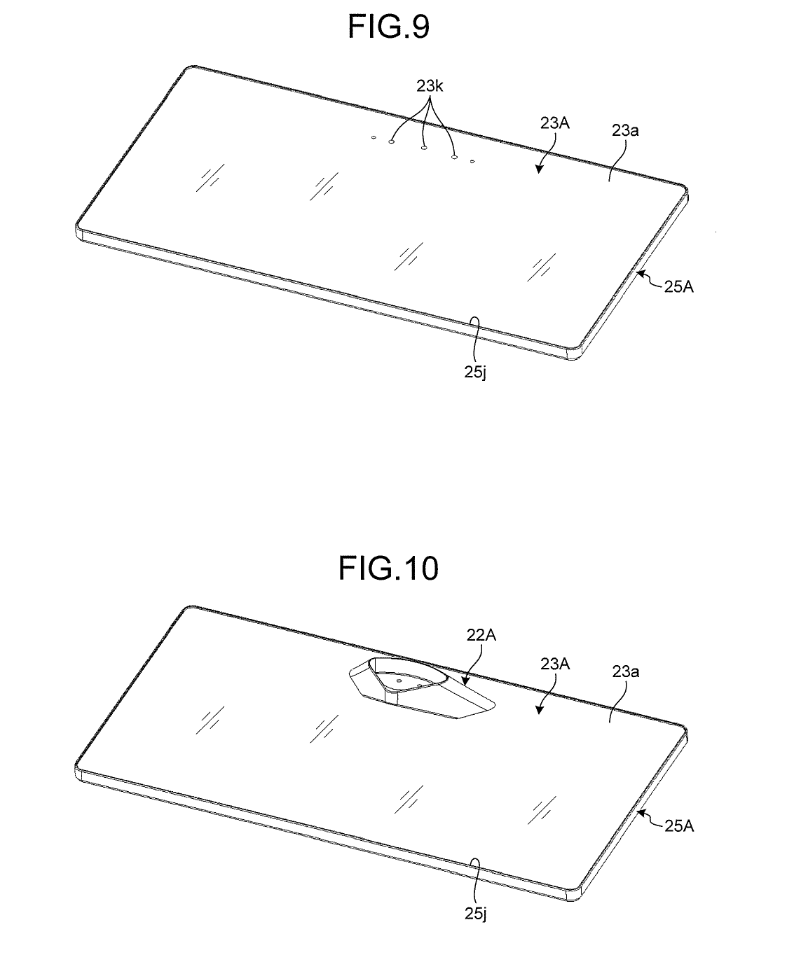

As illustrated in FIGS. 9 and 5, the component 23A is then placed on the structure depicted in FIG. 8, and as illustrated in FIGS. 10 and 5, the component 22A is further placed on the structure depicted in FIG. 9. As illustrated in FIG. 5, the binding tools 30 passing through the openings 24b, 26g, and 23k are then bound to connecting portions 22a provided on the component 22A, whereby the components 24A, 26A, 23A, and 22A are bound (integrated) to be disposed in the foregoing order. Consequently, the supporting portion 2A in which the components 21A to 26A are integrated is constructed. More specifically, in the first embodiment, as one example, the component 23A and the component 26A lie between the component 22A and the component 24A. Accordingly, as one example, a binding structure with these components is more likely to be simplified. Moreover, as one example, the components 22A to 26A are likely to be assembled more easily. Furthermore, as one example, a structure in which the load (mass) of the housing 3A is distributed over the components 23A to 26A via the component 21A and the component 22A is easily obtainable as a relatively simple structure.

In the first embodiment, as illustrated in FIGS. 4 and 5 as one example, the component 22A is supported by the component 23A, the component 24A, and the component 25A in a condition in which the component 22A is separated from the plane P when the supporting portion 2A is placed on the plane P. The component 24A supports the component 23A such that, when the component 23A is placed on the plane P, the end portion 23e of the component 23A positioned on the front side of the screen 4a is in a position closer to the plane P than the end portion 23c positioned on the side opposite to the end portion 23e (back side of the screen 4a) (in the first embodiment, an inclined position as one example). The structures and shapes of the components 23A, 24A, and 25A can be implemented with a variety of changes.

Furthermore, in the first embodiment, as illustrated in FIGS. 11 to 13 as one example, on portions of the component 25A corresponding to (covering) the corners 23g to 23j of the component 23A, the wall portions 25g are cut out. This makes the component 25A pliable along the corners 23g to 23j. Cutouts 25i of the wall portions 25g accommodate respective projecting portions 26i (protrusions) provided on the component 26A. More specifically, the projecting portions 26i fill in the cutouts 25i (openings). Consequently, in accordance with the first embodiment, as one example, the rigidity and strength of the supporting portion 2A are likely to be prevented from deteriorating at the portions in which the cutouts 25i of the component 25A are provided. In the first embodiment, as one example, the projecting portions 26i project from surfaces 25k (lower surfaces, bottom surfaces, or reverse surfaces) of the wall portions 25g of the component 25A. Accordingly, when the projecting portions 26i are composed of elastic bodies (synthetic resin material, elastomer, or the like), the projecting portions 26i can serve as buffering members (protecting members or impact absorbing members).

As in the foregoing, in the first embodiment, as one example, the supporting portion 2A as a stand for a television receiver 1 comprises the component 23A (a first supporting portion), the component 25A (a second supporting portion), the component 22A (a third supporting portion), and the component 24A (a fourth supporting portion). The component 23A has a transparent area on the plane P side of the housing 3A in a direction orthogonal to the plane P when placed on the plane P, and is in a plate-like shape (flat). The component 25A is positioned at the circumferential edge portions of the component 23A. The component 22A is supported by the component 23A and the component 25A, and supports the housing 3A to be rotatable about the axis Ax along a direction intersecting the plane P when placed on the plane P. The component 24A supports the component 23A such that, when the component 23A is placed on the plane P, the end portion 23e (a first end portion) of the component 23A positioned on the front side of the screen 4a is in a position closer to the plane P than the end portion 23c (a second end portion) positioned on the side opposite to the end portion 23e. Consequently, in accordance with the first embodiment, as one example, the area in which the component 23A and the component 24A overlap with each other in the line of sight in a direction orthogonal to the plane P when the supporting portion 2A is placed on the plane P is likely to be smaller. Furthermore, in accordance with the first embodiment, as one example, a dual system by the component 23A and the component 25A can be constructed.

Moreover, in the first embodiment, as one example, the component 24A supports the component 23A on the back side than a central portion of the component 23A in the front-back direction (in the first embodiment, as one example, on the back side than the screen 4a of the housing 3A, or on the back side of the screen 4a with respect to the housing 3A (the surface 3b thereof)). Consequently, in accordance with the first embodiment, as one example, the component 24A becomes harder to be seen when viewed from the front side (frontal side). Furthermore, as one example, the area in which the component 23A and the component 24A overlap with each other is likely to be smaller.

In a conventional stand (a supporting portion) having a flat portion, the flat portion houses therein a supporting structure composed of metallic material and such, and a plate-like cover covers the supporting structure. Accordingly, when the cover is transparent, the supporting structure inside can be seen through, thereby spoiling the whole appearance, and thus there are some cases in which it is hard to make the cover transparent. In this regard, in the first embodiment, as one example, the component 23A is inclined, as it extends from the component 22A (a rotary supporting portion) towards the front side (frontal side) of the screen 4a, from the side away from the plane P to the side closer to the plane P (downwards to the left in FIG. 4) when placed on the plane P, and the component 24A comprises the inclined portion 24f. The inclined portion 24f is inclined, as it extends from the component 22A towards the rear side (back side) of the screen 4a, from the side away from the plane P to the side closer to the plane P (downwards to the right in FIG. 4) when placed on the plane P. Consequently, in accordance with the first embodiment, as one example, because the component 23A serves as a supporting portion of the housing 3A, the supporting structure of other than the component 23A is likely to be smaller, and the transparent area of the component 23A is more likely to be expanded. In the first embodiment, as one example, the component 24A itself is inclined, as it extends from the component 22A towards the rear side of the screen 4a, from the side away from the plane P to the side closer to the plane P when placed on the plane P.

Furthermore, in the first embodiment, as one example, the inclined portion 22b on the front side of the component 22A is inclined, as it extends towards the rear side of the screen 4a, from the side away from the plane P to the side closer to the plane P (downwards to the right in FIG. 4) when placed on the plane P. Consequently, in accordance with the first embodiment, as one example, when viewed from the front side of the screen 4a, the area in which the component 22A and the component 24A are visible is more likely to be reduced.

In the first embodiment, as one example, the wall portion 25h of the component 25A as a connecting portion to the component 24A is positioned between the component 23A and the component 24A. This means that, in accordance with the first embodiment, as one example, the component 25A and the component 24A are more likely to be connected in a simple structure.

In the first embodiment, as one example, the component 25A (the wall portions 25e to 25g thereof) covers the end portions 23c to 23f of the component 23A. Consequently, in accordance with the first embodiment, as one example, the end portions 23c to 23f of the component 23A are likely to be prevented from being damaged.

In the first embodiment, as one example, the component 25A covers the end portion 23e of the component 23A. Therefore, in accordance with the first embodiment, as one example, the end portion 23e is likely to be prevented from being damaged by an external force and such acting from the placement surface side.

Modification

A supporting portion 2B according to a modification illustrated in FIG. 14 can replace the supporting portion 2A. The supporting portion 2B in the present modification comprises not the component 23A but a component 23B (a first supporting portion) as laminated glass. In accordance with the present modification, as one example, the strength of the component 23B is more likely to be increased. The component 23B further comprises a first glass portion 23m (a first portion) and a second glass portion 23n (a second portion) bound to each other, for example, with an adhesion layer (not depicted) interposed therebetween. The first glass portion 23m is disposed on the side closer to the plane P when placed on the plane P (the lower side, i.e., the upper side in FIG. 14). The second glass portion 23n (thickness: t2) is placed on the side farther away from the plane P than the first glass portion 23m (the upper side, i.e., the lower side in FIG. 14), overlapping with the first glass portion 23m (thickness: t1), and is thinner than the first glass portion 23m (t2<t1). Consequently, in accordance with the present modification, as one example, when an external force acts on the component 23B from above such as an object falling off and hitting on the component 23B, the second glass portion 23n disposed on the upper side is likely to be damaged before the first glass portion 23m disposed on the lower side is. This makes it easier, as one example, for the user, for example, to find that the second glass portion 23n is damaged. Consequently, as one example, the replacement of the supporting portion 2B is likely to be prompted. Furthermore, as one example, even when the second glass portion 23n is damaged, the necessary rigidity and strength are likely to be retained by the first glass portion 23m.

In the present modification, the supporting portion 2B does not comprise the component 26A. The cutouts 25i of the component 25A accommodate components 28B (spacers). The components 28B are provided for the respective corners 23g to 23j of the component 23B. The components 28B can be composed of elastic members (for example, elastomer or synthetic resin material). In this case, the components 28B can be inserted from above in FIG. 14 (the lower side (underside) in an installed condition) and fitted in the cutouts 25i. Furthermore, in the present modification, a buffering member 29 (a protecting member or an impact absorbing member) formed in a sheet, a thin plate, or a film can be present between the component 23B and the component 25A. The present modification can yield similar results (effects) based on a similar structure to that in the first embodiment.

### Second Embodiment

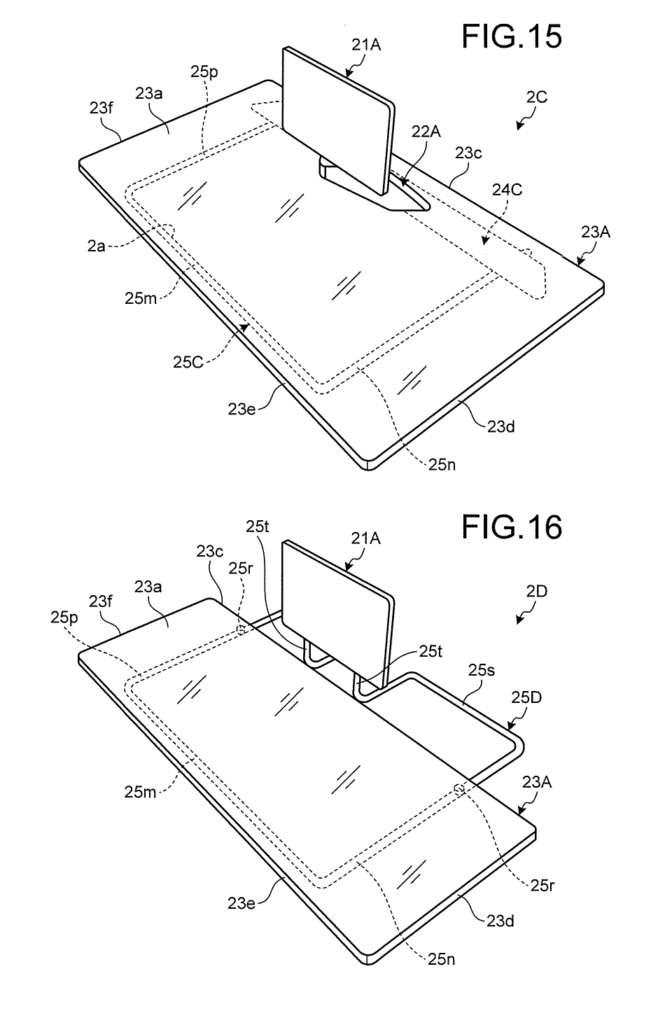

A supporting portion 2C according to a second embodiment illustrated in FIG. 15 can be used to substitute for the supporting portion 2A. The supporting portion 2C in the second embodiment comprises not the component 25A but a component 25C. The component 25C can be constructed, as one example, with a bar-shaped (linear, elongated; for example, rod, square-bar, or cylindrical) member being bent. Also in the second embodiment, a dual system by the component 23A and the component 25C is constructed. The lower portion of a component 24C substituting for the component 24A has recessed portions (not depicted) in which parts of the component 25C are accommodated (passed through). The component 24C and the component 25C can be connected by binding tools (screws and such, not depicted), welding, and others at the portions of the recessed portions in which the component 24C and the component 25C overlap with each other. The component 25C comprises a portion 25m (an extending portion or an arm portion) extending in parallel with and along the end portion 23e of the component 23A, and portions 25n and 25p (extending portions or arm portions) extending in parallel with and along the respective end portions 23d and 23f of the component 23A. In the component 25C, the portions 25m, 25n, and 25p are arranged in a U-shaped form. The component 24C and the component 25C form an opening 2a. The component 23A covers the opening 2a. The component 25C can be composed of, as one example, metallic or synthetic resin material. The second embodiment can yield similar results based on the structures and shapes having similar functions to those in the first embodiment and the modification described above.

### Third Embodiment

A supporting portion 2D according to a third embodiment illustrated in FIG. 16 can be used to substitute for the supporting portion 2A. The supporting portion 2D in the third embodiment comprises a component 25D that substitutes for the component 24C, the component 25C, and the component 22A in the second embodiment. In other words, the component 25D has three functions of the components 24C, 25C, and 22A in the second embodiment. The component 25D comprises portions 25m, 25n, and 25p having the same functions as the function of the component 25C. The portions 25n and 25p are provided with projecting portions 25r (protrusions) projecting upward (in a direction to be away from the plane P when placed on the plane 2). The projecting portions 25r have the same function as that of the component 24C. More specifically, the projecting portions 25r support the component 23A to be in the same position as in the above-described embodiments (in the third embodiment, an inclined position as one example). The component 25D further comprises portions 25s positioned on the side opposite to the portion 25m connected to the portions 25n and 25p, and portions 25t projecting upward from the portions 25s. The portions 25t have the same function as that of the component 22A. In the third embodiment, the component 25D does not have a function to support the component 21A to be rotatable about the axis Ax. However, by placing the component 22A that comprises the swivel structure 27A (a rotary supporting structure) between the component 25D and the component 21A, it is possible to support the component 21A to be rotatable by the component 22A. In the third embodiment, as one example, the component 23A (a member) does not contribute to the support of the housing 3A. More specifically, the supporting portion 2D (a supporting structure) comprises the component 25D but not the component 23A. The component 25D and the component 23A are bound to each other by binding tools (screws as one example, not depicted), components (not depicted), or adhesives. The component 25D can be composed of, as one example, metallic or synthetic resin material. The third embodiment can yield similar results based on the structures and shapes having similar functions to those in the embodiments and the modification described above.

While the embodiments of the present invention have been exemplified in the foregoing, these embodiments have been presented by way of example only, and are not intended to limit the scope of the invention. These embodiments described herein maybe embodied in a variety of other forms, and various omissions, substitutions, combinations, and changes to the embodiments can be made without departing from the spirit of the invention. These embodiments and such modifications would fall within the scope and spirit of the invention and are intended to be covered by the accompanying claims and their equivalents. Furthermore, the structures and shapes in the embodiments described above can be implemented while partially replaced with one another. The specifications (such as the structure, type, direction, shape, size, length, width, thickness, height, number of pieces, arrangement, position, material, color, clarity, refractive index, and reflectance) of each of the structures and shapes can be implemented with appropriate changes. For example, the structure, shape, arrangement, combination, and such of each of the components of the supporting portions (supporting configurations) illustrated in the above-described embodiments and the modification are illustrative only. More specifically, for example, adopted can be a structure, shape, arrangement, and combination of a supporting portion (a supporting configuration) other than those in the foregoing embodiments and modification such as a structure comprising a component integrating a plurality of supporting portions or a structure comprising a plurality of components for a single supporting portion. Furthermore, the first supporting portion is not necessarily completely flat (a plate-like shape) and may have slight irregularities. While the first supporting portion (the component 23A or 23B) is transparent in all of the embodiments and the modification, the first supporting portion that is opaque can still provide some advantages, for example, the supporting portion can be further simplified or the appearance can be enhanced. Moreover, the second supporting portion can be constructed with various changes in its specifications.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video display device comprising:
a housing provided with a display device comprising a screen;
a first supporting portion in a plate-like shape comprising a transparent area, the transparent area being, when the first supporting portion is placed on a plane, on a side of the plane of the housing in a direction orthogonal to the plane;
a second supporting portion positioned at a circumferential edge portion of the first supporting portion;
a third supporting portion supported by the first supporting portion and the second supporting portion and configured to support the housing to be rotatable about an axis along a direction intersecting the plane when the first supporting portion is placed on the plane; and
a fourth supporting portion configured to support the first supporting portion to be in a position in which a first end portion of the first supporting portion positioned on a front side of the screen is closer to the plane than a second end portion on a side opposite to the first end portion of the first supporting portion when the first supporting portion is placed on the plane.

2. The video display device of claim 1, wherein the fourth supporting portion is configured to support the first supporting portion on a back side of the screen with respect to the housing.

3. The video display device of claim 1, wherein
the second supporting portion and the fourth supporting portion are connected, and
a connecting portion of the second supporting portion connecting to the fourth supporting portion is positioned between the third supporting portion and the fourth supporting portion.

4. The video display device of claim 1, wherein the second supporting portion is configured to cover an end portion of the first supporting portion.

5. The video display device of claim 4, wherein the second supporting portion is configured to cover the first end portion.

6. The video display device of claim 1, wherein the first supporting portion comprises laminated glass.

7. The video display device of claim 6, wherein the first supporting portion comprises a first portion and a second portion, the second portion being configured to overlap with the first portion, to be farther away from the plane than the first portion when placed on the plane, and to be thinner than the first portion.

8. A video display device comprising:
a housing provided with a display device comprising a screen;
a rotary supporting portion configured to rotatably support the housing on a side opposite to the screen;
a first supporting portion configured to be flat and to support the rotary supporting portion, the first supporting portion being inclined, as the first supporting portion extends from the rotary supporting portion towards a front side of the screen, from a side away from a plane to a side closer to the plane when placed on the plane; and
a second supporting portion configured to support the rotary supporting portion, the second supporting portion comprising an inclined portion being inclined, as the inclined portion extends from the rotary supporting portion towards a back side of the screen, from a side away from the plane to a side closer to the plane when placed on the plane.

9. The video display device of claim 8, wherein the rotary supporting portion comprises an inclined portion positioned on a front side of the screen and inclined, as the inclined portion extends towards a back side of the screen, from a side away from the plane to a side closer to the plane when placed on the plane.

10. A video display device comprising:
a housing provided with a display device;
a supporting structure configured to support the housing; and
a member connecting to the supporting structure, the member expanding, when the supporting structure is placed on a plane, along a direction intersecting a direction orthogonal to the plane, wherein
the member is configured to comprise a transparent area not overlapping with the supporting structure on a side of the plane of the housing viewed from a direction orthogonal to the plane when the supporting structure is placed on the plane, and is connected to the supporting structure on a circumferential edge side of the member.

11. The video display device of claim 10, wherein the member comprises a portion covering the supporting structure from a side farther away from the plane when the supporting structure is placed on the plane.

12. The video display device of claim 10, wherein the supporting structure is configured to support the member in an inclined condition with respect to the plane when the supporting structure is placed on the plane.
